(19) United States
(12) Patent Application Publication
(10) Pub. No.: US 2021/0017086 A1
(43) Pub. Date: Jan. 21, 2021

(54) High Temperature Resistant Cemented Carbide and Manufacturing Method Thereof

(71) Applicant: SHANDONG INSTITUTE OF MECHANICAL DESIGN AND RESEARCH, Linan City (CN)

(72) Inventor: Bo LI, Jinan (CN)

(21) Appl. No.: 16/931,392

(22) Filed: Jul. 16, 2020

(30) Foreign Application Priority Data
Jul. 17, 2019 (CN) 201910643653.4

(51) Int. Cl. C04B 35/56; C04B 35/63; C04B 35/645

(52) U.S. Cl. CPC C04B 35/5626; B82Y 40/00; C04B 35/6455; C04B 35/6316

(57) ABSTRACT

A high temperature resistance cemented carbide is sintered from a tungsten carbide powder and a binder phase powder, wherein the mass percentage of the tungsten carbide powder is 60% to 92% and the mass percentage of the binder phase powder is 8% to 40%. The binder phase powder includes 40 to 90 parts of molybdenum, 10 to 60 parts of cobalt, 0.001 to 0.11 part of boron, 0.001 to 0.02 part of technetium, 1 to 7 parts of silicon, and 2 to 10 parts of manganese. The cemented carbide that can withstand high temperatures and maintain good hardness when used in high temperature environments.

### CROSS REFERENCE OF RELATED APPLICATION

This application is a non-provisional application that claims priority under 35U.S.C. § 119 to China application number CN201910643653.4, filed on Jul. 17, 2019, which are incorporated herewith by references in their entities.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### FIELD OF INVENTION

The present invention relates to the field of metallurgy, and more particularly to a high temperature resistant cemented carbide and manufacturing method thereof.

### DESCRIPTION OF RELATED ARTS

Cemented carbide is an alloy material made from hard compound of refractory metal and bonding metal by a powder metallurgy process. Due to its high hardness and wear resistance, it is widely used in cutting tool materials, machining, aerospace, steelmaking, and other fields.

Cemented carbide is mainly made by mixing powders of tungsten carbide and cobalt, and undergoing a power metallurgy process including steps of powder fabricating, ball milling, pressing, and sintering. When in use, cemented carbide of suitable materials should be chosen according to different applications. The contents of tungsten carbide and cobalt in cemented carbides of different uses are not the same.

Conventional cemented carbide on the market has a poor heat resistant performance, it generally has good hardness, at a temperature below 600° C. However, in applications such as steelmaking, when the temperature exceeds 1200° C., its hardness is reduced and deformation is easy to occur. Therefore, there is a need for a cemented carbide that can withstand high temperatures and maintain good hardness when used in high temperature environments.

### SUMMARY OF THE PRESENT INVENTION

The invention is advantageous in that it provides a cemented carbide that can withstand high temperatures and maintain good hardness when used in high temperature environments.

Additional advantages and features of the invention will become apparent from the description which follows, and may be realized by means of the instrumentalities and combinations particular point out in the appended claims.

According to the present invention, the foregoing and other objects and advantages are attained by a high temperature resistant cemented carbide, wherein the cemented carbide is sintered from tungsten carbide powder and binder phase powder, wherein the mass percentage of the tungsten carbide powder is 60% to 92%, the mass percentage of the binder phase powder is 8% to 40%. A sum of the mass percentages of compositions of a powder mixture of the cemented carbide is 100%. The binder phase powder comprises 40 to 90 parts of molybdenum powder, 10 to 60 parts of cobalt, 0.001 to 0.11 part of boron, 0.001 to 0.02 part of technetium, 1 to 7 parts of silicon and 2 to 10 parts of manganese.

Preferably, the particle size of the tungsten carbide powder is 1 to 100 nm, wherein the particle size of the binder phase powder is 1 to 100 nm.

According to another aspect of the present invention, the present invention provides a manufacturing method of the above high temperature resistant cemented carbide, wherein the method comprises the following steps.

(a) Manufacture tungsten carbide powder and binder phase powder.

(b) Mix the tungsten carbide powder and the binder phase powder in predetermined proportion to form a first mixed powder.

(c) Add molding agent to the first mixed powder to form a second mixed powder.

(d) Compression mold the second mixed powder to obtain a molded material.

(e) Isostatic sinter the molded material.

Preferably, the method for manufacturing the tungsten carbide comprising the following steps.

(A) Place tungsten carbide target into an argon vacuum sputtering machine, so as to bombard the tungsten carbide with argon ions to form a target powder, wherein the tungsten carbide target is made of tungsten carbide plate or bar.

(B) Keep the argon vacuum sputtering machine being standing still for 10 to 25 days to allow the target powder to drop into a powder collection bottle through a hopper device provided in the vacuum chamber of the argon vacuum sputtering machine, so as to obtain the tungsten carbide powder.

Preferably, the method for manufacturing the binder phase powder comprising the following steps.

(α) Obtain a binder phase alloy, wherein the binder phase alloy is made from molybdenum, cobalt, boron, technetium, silicon and manganese which are melted, uniformed, and alloyed at a first predetermined temperature according to predetermined parts by mass.

(β) Place the binder phase alloy target into an argon vacuum sputtering machine, so as to bombard the binder phase alloy with argon ions to form a binder powder.

(γ) Keep the argon vacuum sputtering machine being standing still for 10 to 25 days to allow the binder powder to drop into a powder collection bottle through a hopper device provided in the vacuum chamber of the argon vacuum sputtering machine, so as to obtain the binder phase powder.

Preferably, the step (e) comprises the following steps.

(e1) Put the molded material into a sintering furnace.

(e2) Evacuate the sintering furnace and heat the sintering furnace to a second predetermined temperature and keep the second predetermined temperature in the sintering furnace for 0.5 to 2.0 h.

(e3) Feed argon into the sintering furnace till a pressure in the sintering furnace reaches to 8 to 15 MPa.

(e4) Maintain the temperature in the sintering furnace for 3 to 6 h.

(e5) Cool the sintering furnace to room temperature.

According to another aspect of the present invention, the present invention provides a high temperature resistant cemented carbide. The high temperature resistant cemented carbide is sintered from tungsten carbide powder and binder phase powder, wherein the mass percentage of the tungsten carbide powder is 60% to 92%, the mass percentage of the binder phase powder is 40% to 8%. A sum of the mass percentages of compositions of a powder mixture of the cemented carbide is 100%. The binder phase powder comprises 40 to 90 parts by mass of molybdenum powder, 10 to 60 parts by mass of cobalt powder, 0.001 to 0.11 part by mass of boron powder, 0.001 to 0.02 part by mass of technetium powder, 1 to 7 parts by mass of silicon powder and 2 to 10 parts by mass of manganese powder. Molybdenum, cobalt, boron, technetium, silicon and manganese function as binder phase materials. Cobalt has good wettability, but because of its low melting point, cobalt cannot be used alone for high temperature resistance. It must be solved by using an alloy with molybdenum. Molybdenum alloy has good thermal conductivity, electrical conductivity, low expansion coefficient, high strength and high recrystallization temperature at high temperature, and be easy for processing. Silicon has high temperature resistance, toughness, cuttability, and oxidation stability and weather resistance. Boron has high temperature lubricity, and can promote the permeability and affinity of various elements, but is slightly brittle, while manganese has the effect of improving structural strength, improving comprehensive properties and improving toughness, offsetting the brittleness weakness of boron. Molybdenum is easy to oxidize under high temperature environment. Adding a small amount of technetium powder has anti-oxidation and anti-corrosion effects, effectively solving the tendency of molybdenum to be easily oxidized under high temperature environment and the long-term oxidation and corrosion resistance of the entire alloy under high temperature. The combination of these six alloys effectively makes up for the performance defects of each element, and gives full play to the advantages of each element, so that the comprehensive performance of the binder phase reaches the best state. The cemented carbide obtained by mixing and sintering the binder phase with tungsten carbide in proportion has excellent properties such as high temperature resistance, toughness, high temperature oxidation resistance and wettability, and has the best comprehensive performance. High temperature cemented carbide obtained according to this method, its hardness is at a higher temperature (such as 1000 to 2000° C.) is HRC 55 to 64, normal temperature compressive strength is 4.0 to 6.8 GPa, and it has certain toughness, high temperature oxidation resistance, acid and alkali resistance, and low thermal expansion coefficient.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram of a manufacturing method of a high temperature resistant cemented carbide according to a preferred embodiment of the present invention.

FIG. 2 is a schematic view of an argon vacuum sputtering machine according to the above preferred embodiment of the present invention.

FIG. 3 is a flow diagram of a method of manufacturing a tungsten carbide powder according to the above preferred embodiment of the present invention.

FIG. 4 is a flow diagram of a method of manufacturing a binder phase powder according to the above preferred embodiment of the present invention.

FIG. 5 is a flow diagram of an isostatic sinter process according to the above preferred embodiment of the present invention.

FIG. 6 is a flow diagram illustrating a manufacturing method of a high temperature resistant cemented carbide according to a first example of the above preferred embodiment of the present invention.

FIG. 7 is a flow diagram illustrating a manufacturing method of a high temperature resistant cemented carbide according to a second example of the above preferred embodiment of the present invention.

FIG. 8 is a flow diagram illustrating a manufacturing method of a high temperature resistant cemented carbide according to a third example of the above preferred embodiment of the present invention.

FIG. 9 is a flow diagram illustrating a manufacturing method of a high temperature resistant cemented carbide according to a fourth example of the above preferred embodiment of the present invention.

FIG. 10 is a flow diagram illustrating a manufacturing method of a high temperature resistant cemented carbide according to a fifth example of the above preferred embodiment of the present invention.

FIG. 11 is a flow diagram illustrating a manufacturing method of a high temperature resistant cemented carbide according to a sixth example of the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

A preferred embodiment of the present invention provides a high temperature resistant cemented carbide. The high temperature resistant cemented carbide is sintered from tungsten carbide powder and binder phase powder, wherein the mass percentage of the tungsten carbide powder is 60% to 92%, the mass percentage of the binder phase powder is 8% to 40%. It is worth mentioning that a sum of the mass percentages of compositions of a powder mixture of the cemented carbide is 100%. The binder phase powder comprises 40 to 90 parts of molybdenum powder, 10 to 60 parts of cobalt powder, 0.001 to 0.11 part of boron powder, 0.001 to 0.02 part of technetium powder, 1 to 7 parts of silicon powder and 2 to 10 parts of manganese powder. According to the preferred embodiment of the present invention, the particle sizes of the tungsten carbide powder and the binder phase powder are both 1 to 100 nm.

It is worth mentioning that the production of cemented carbides with different temperature resistance requires different binder phase materials. Since the main components of the binder phase material are molybdenum and cobalt, the temperature resistance performances of the binder phase material are mainly related to the mass ration between molybdenum and cobalt. More specifically, the relationship between the temperature resistance of the binder phase material and the mass ration between molybdenum and cobalt can refer to the phase diagram of molybdenum and cobalt alloy.

For example, when cemented carbide with a temperature resistance of 1600° C. is produced, the melting temperature of the binder phase is 2000° C. , and the mass of molybdenum powder is 75% of the total mass of molybdenum powder and cobalt powder. When cemented carbide with a temperature resistance of 1600 ° C. is produced, the melting temperature of the binder phase is 2000° C., and the mass of molybdenum powder is 75% of the total mass of molybdenum powder and cobalt powder. When cemented carbide with a temperature resistance of 1800° C. is produced, the melting temperature of the binder phase is 2200° C. , and the mass of molybdenum powder is 82% of the total mass of molybdenum powder and cobalt powder. When cemented carbide with a temperature resistance of 2000° C. is produced, the melting temperature of the binder phase is 2400° C., and the mass of molybdenum powder is 90% of the total mass of molybdenum powder and cobalt powder.

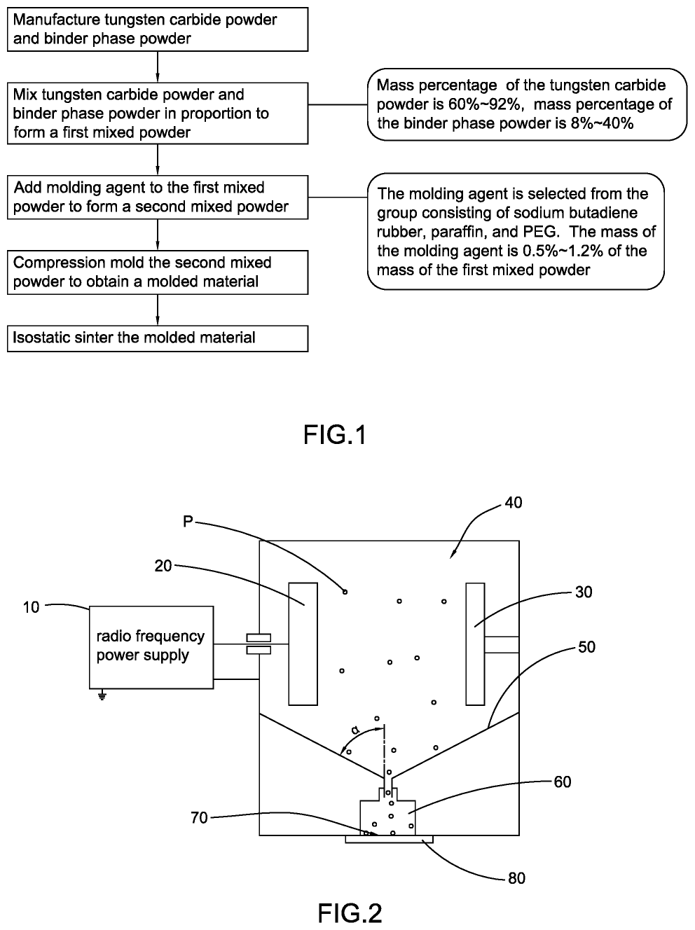

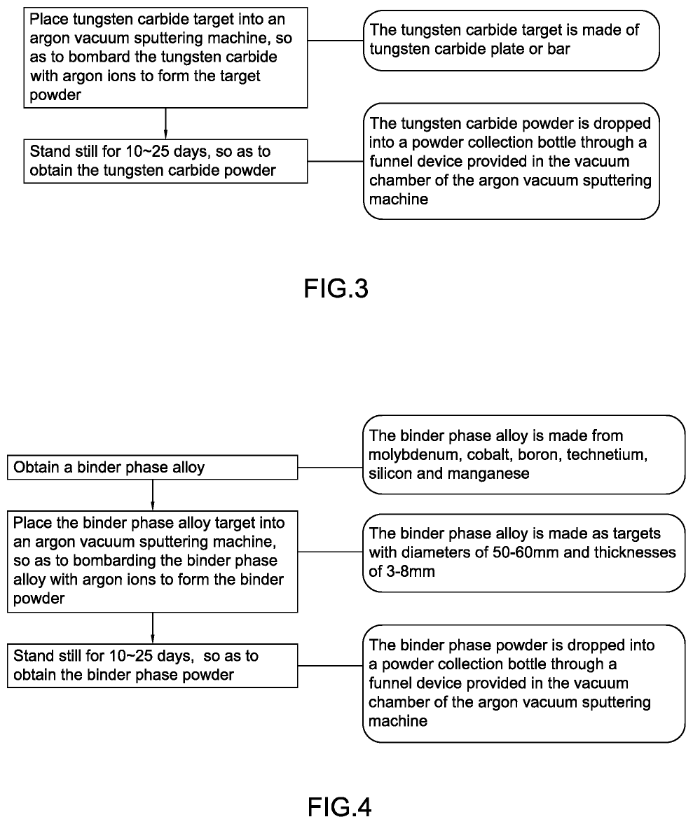

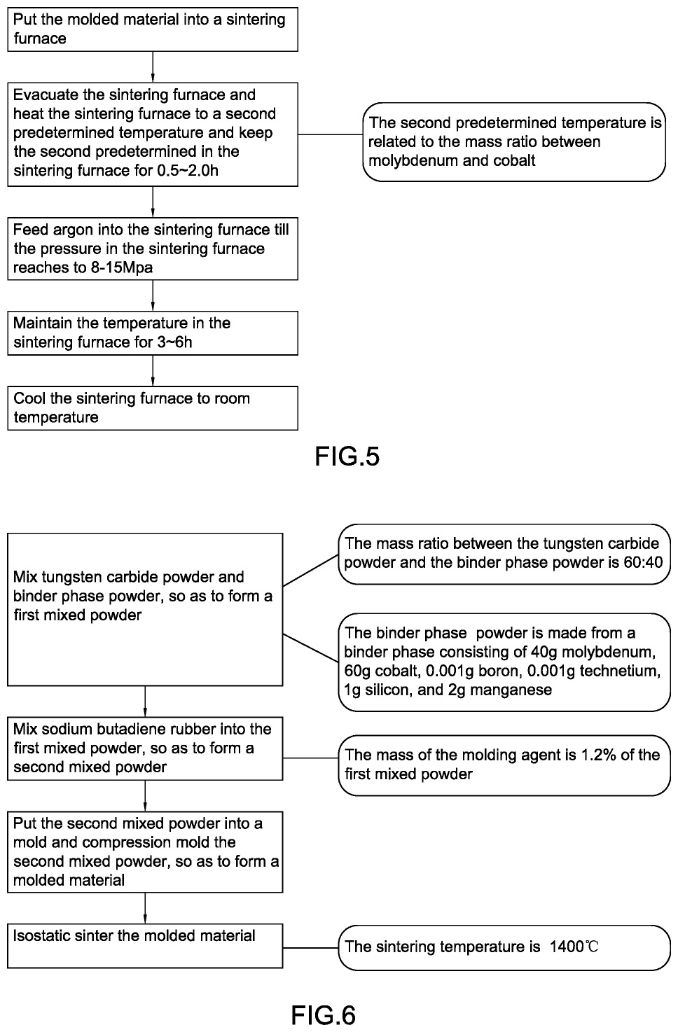

Referring to FIG. 1 of the drawings, a method of manufacturing the above high temperature resistant cemented carbide is illustrated. The manufacturing method comprises the following steps.

Manufacture tungsten carbide powder and binder phase powder, and mix the tungsten carbide powder, the binder phase powder and molding agent.

More specifically, mix the tungsten carbide powder and the binder phase powder in proportion to form a first mixed powder, wherein the mass percentage of the tungsten carbide powder is 60% to 92%, wherein the mass percentage of the binder phase powder is 8% to 40%. In other words, the sum of the mass percentage of the tungsten carbide powder and the mass percentage of the binder phase powder is 100%. It is worth mentioning that, according to this first preferred embodiment of the present invention, in order to evenly mix the tungsten carbide powder and the binder phase powder, the mixing step can be accomplished with a mixer.

Add molding agent to the first mixed powder to form a second mixed powder, wherein the molding agent is selected from the group consisting of sodium butadiene rubber, paraffin, and PEG, wherein the mass of the molding agent is 0.5% to 1.2% of the mass of the first mixed powder. According to this preferred embodiment of the present invention, the specific percentage of the mass of the molding agent and the mass of the first mixed powder is inversely proportional to the proportion of the tungsten carbide powder in the first mixed powder. For example, when the proportion of tungsten carbide powder in the first mixed powder is 92%, the mass of the molding agent is 0.5% of the first mixed powder. When the proportion of tungsten carbide powder in the first mixed powder is 60%, the mass of the molding agent is 1.2% of the first mixed powder. It is worth mentioning that, according to this preferred embodiment of present invention, the mixing of the first mixed powder and the molding agent is accomplished with a mixer.

Compression mold the second mixed powder to provide a molded material, wherein the second mixed powder is compressed with a pressing machine in the mold to obtain required density, uniformity, shape and dimensional accuracy. During the thermal forming process, thermal pressing is also required, and the external dimensions of the workpiece will be reduced by compression. Therefore, the size of the mold needs to be increased by 5% to 30%.

Isostatic sinter the molded material.

It is worth mentioning that there are many methods for manufacturing the tungsten carbide powder and the binder phase powder, such as wet grinding process suitable for a large-scale production of the carbide powder and the binder phase powder. For small-scale cemented carbide productions with multiple varieties, an argon vacuum sputtering machine as shown in FIG. 2 can be used. Referring to FIG. 2 of the drawings, the argon vacuum sputtering machine comprises a radio frequency power supply 10 and a cathode 30, and has a vacuum chamber 40. The cathode 30 is disposed in the vacuum chamber 40. A target 20 is provided in the vacuum chamber 40, so as to be bombarded in the vacuum chamber 40. Because the particles generated by sputtering are at the nanometer level, it is difficult to collect the particles that float in the air after being generated. According to this preferred embodiment of the present invention, the argon vacuum sputtering machine further comprises a hopper device 50 and a powder collection device 60. According to this preferred embodiment of the present invention, the powder collection device is embodied as a powder collection bottle 60. The hopper device 50 and the collection bottle 60 are provided in the vacuum chamber 40. It is worth mentioning that the hopper device 50 has a top large opening and a bottom small opening, wherein the diameter of the large opening is the same as the inner diameter of the vacuum chamber 40, so that the hopper device 50 can collect the particles P, which are generated by sputtering to the greatest extent, and that the particles P can finally fall into the powder collection bottle 60 through the hopper device 50, so as to facilitate powder collection.

As can be shown in FIG. 2 of the drawings, the argon vacuum sputtering machine further has an outlet 70. The size of the outlet 70 matches the size of the collection bottle 60, so that the collection bottle 60 can be taken out and put into the vacuum chamber 40. It is worth mentioning that the argon vacuum sputtering machine further comprises a movable cover 80 matches well with the outlet 70, so that the outlet 70 can be well covered.

Referring to FIG. 2 of the drawings, a tilt angle a is defined between an inclined inner wall of the hopper device 50 and a vertical line. According to this preferred embodiment of the present invention, the tilt angle α≤45° , so that the powder can fall into the powder collection bottle 60 easily.

According to this preferred embodiment of the present invention, the method for manufacturing the tungsten carbide comprises the following steps.

Place tungsten carbide target into an argon vacuum sputtering machine, so as to bombard the tungsten carbide with argon ions to form a target powder, wherein the tungsten carbide target is made of tungsten carbide plate or bar.

Keep the argon vacuum sputtering machine being standing still for 10 to 25 days, so that the tungsten carbide powder is dropped into a powder collection bottle through a hopper device provided in the vacuum chamber of the argon vacuum sputtering machine, so as to obtain the tungsten carbide powder.

According to this preferred embodiment of the present invention, the method for manufacturing the binder phase powder comprises the following steps.

Obtain a binder phase alloy, wherein the binder phase alloy is made from molybdenum, cobalt, boron, technetium, silicon and manganese which are melted, uniformed, and alloyed at a first predetermined temperature according to predetermined parts by mass, wherein the first predetermined temperature is set at 200° C. higher than the melting temperature of the binder phase alloy, wherein the melting temperature of the binder phase alloy can be determined according to the mass ration between molybdenum and cobalt by referring to molybdenum-cobalt alloy phase diagram. Molybdenum, cobalt, boron, technetium, silicon and manganese are put into a vacuum heater in predetermined parts by mass. The molybdenum, cobalt, boron, technetium, silicon and manganese are gradually heated to the first predetermined temperature for alloying. After the alloying process is finished, the alloy formed by molybdenum, cobalt, boron, technetium, silicon and manganese is cooled to room temperature in a vacuum environment.

Place the binder phase alloy target into an argon vacuum sputtering machine, so as to bombard the binder phase alloy with argon ions to form a binder powder. More specifically, the binder phase alloy is made as targets with diameters of 50 to 60 mm and thicknesses of 3 to 8 mm. The targets are put into the argon vacuum sputtering machine, so that the targets are bombarded by argon ions, so as to form the binder powder.

Keep the argon vacuum sputtering machine being standing still for 10 to 25 days, so that the binder powder is dropped into a powder collection bottle through a hopper device provided in the vacuum chamber of the argon vacuum sputtering machine, so as to obtain the binder phase powder.

According to this preferred embodiment of the present invention, the isostatic sintering step comprises the following steps.

Put the molded material into a sintering furnace.

Evacuate the sintering furnace and heat the sintering furnace to a second predetermined temperature and keep the second predetermined temperature in the sintering furnace for 0.5 to 2.0 h.

Feed argon into the sintering furnace till the pressure in the sintering furnace reaches to 8 to 15 MPa.

Maintain the temperature in the sintering furnace for 3 to 6 h.

Cool the sintering furnace to room temperature.

It is worth mentioning that the second predetermined temperature is related to the mass ration between molybdenum and cobalt. According to this preferred embodiment of the present invention, the second predetermined temperature is set at 200° C. higher than the melting point of the Mo—Co alloy.

According to this preferred embodiment of the present invention, molybdenum, cobalt, boron, technetium, silicon and manganese function as binder phase materials. Cobalt has good wettability, but because of its low melting point, cobalt cannot be used alone for high temperature resistance. It must be solved by using an alloy with molybdenum. Molybdenum alloy has good thermal conductivity, electrical conductivity, low expansion coefficient, high strength and high recrystallization temperature at high temperature, and is easy to process. Silicon has high temperature resistance, toughness, cuttability, and oxidation stability and weather resistance. Boron has high temperature lubricity, and can promote the permeability and affinity of various elements, but is slightly brittle, while manganese has the effect of improving structural strength, improving comprehensive properties and improving toughness, offsetting the brittleness weakness of boron. Molybdenum is easy to oxidize under high temperature environment. Adding a small amount of technetium powder has anti-oxidation and anti-corrosion effects, effectively solving the tendency of molybdenum to be easily oxidized under high temperature environment and the long-term oxidation and corrosion resistance of the entire alloy under high temperature. The combination of these six alloys effectively makes up for the performance defects of each element, and gives full play to the advantages of each element, so that the comprehensive performance of the binder phase materials reaches the best state. The cemented carbide obtained by mixing and sintering the binder phase materials with tungsten carbide in proportion has excellent properties such as high temperature resistance, toughness, high temperature oxidation resistance and wettability, and has the best comprehensive performance. High temperature cemented carbide obtained according to this method, its hardness at a higher temperature (such as 1000 to 2000° C.) is HRC 55 to 64, normal temperature compressive strength is 4.0 to 6.8 GPa, and it has certain toughness, high temperature oxidation resistance, acid and alkali resistance, and low thermal expansion coefficient.

FIG. 6 of the drawings illustrates a first example of the manufacturing method of the high temperature resistant cemented carbide according to the preferred embodiment of the present invention. The method comprises the following steps.

Mix 60 g tungsten carbide powder and 40 g binder phase powder, so as to form a first mixed powder.

Mix 1.2 g sodium butadiene rubber into the first mixed powder, so as to form a second mixed powder.

Put the second mixed powder into a mold and compression mold the second mixed powder, so as to form a molded material.

Isostatic sinter the molded material, wherein after the temperature rises to 1400° C., the temperature is maintained for 2 hours. Then release the vacuum pressure and fill argon into the furnace for 3 hours. After the pressure in the furnace reaches to 10 MPa, the temperature is maintained for 6 h.

More specifically, industrial pure tungsten carbide rods or plates are used as targets. The targets are put into an argon vacuum sputtering machine. After the temperature in the argon vacuum sputtering machine is heated to 400-800° C., and the argon pressure is set to 5×10⁻⁶ Pa to 6×10⁻⁶ Pa, the target is bombarded with argon ions to make powder with particle sizes of 1 to 100 nm. After the argon ion bombardment is completed, the inside of the argon vacuum sputtering machine is fed with tungsten carbide powder. Then the argon vacuum sputtering machine is turned off. After the argon vacuum sputtering machine is turned off, leave it for 10 to 25 days, so that the tungsten carbide powder falls freely, and enter into a powder collection bottle 60 through a hopper device 50. After the tungsten carbide powder is collected into the powder collection bottle 60, the outlet 70 of the argon vacuum sputtering machine is opened and the powder collection bottle 60 is removed for later use.

According to this first example, the binder phase material comprises 40 g molybdenum, 60 g cobalt, 0.001 g boron, 0.001 g technetium, 1 g silicon, and 2 g manganese. The binder phase material is melted and alloyed at 1600° C., so as to form targets with diameters of 50 to 60 nm and with thicknesses of 3 to 8 mm. The targets are put into an argon vacuum sputtering machine to produce binder phase powder with particle sizes of 1 to 100 nm. After the argon ion bombardment is completed, the inside of the argon vacuum sputtering machine is fed with binder phase powder. Then the argon vacuum sputtering machine is turned off. After the argon vacuum sputtering machine is turned off, leave it for 10 to 25 days, so that the binder phase powder falls freely, and enter into the powder collection bottle 60 through the hopper device 50. After the binder phase powder is collected into the powder collection bottle 60, the outlet 70 of the argon vacuum sputtering machine is opened and the powder collection bottle is removed for later use.

After 60 g tungsten carbide powder, 40 g binder phase powder and 1.2 g sodium butadiene rubber are mixed together, a second mixed powder is formed. The second mixed powder is put into a mold and compressed, followed by isostatic sintering. The purpose of sintering is to compact the porous powder. During the sintering process, it is further compacted to become a denser alloy with a certain microstructure and properties, which further improves the mechanical properties, so that a workpiece is obtained.

After the workpiece to be sintered is placed on a workpiece holder of the isostatic sintering furnace, the furnace door is closed. Evacuate the air in the isostatic sintering furnace while heating the environment in the isostatic sintering furnace, wherein the heating rate is 700° C./h. After the temperature rises to 1400° C. , the temperature is maintained for 2 h. The vacuum is removed. The argon is filled into the furnace for 3 h.

The pressure in the furnace reaches 10 MPa, and the temperature is maintained for 6 hours. Turn off the power, cool down to room temperature, and the sintering is completed to obtain a high-temperature resistance cemented carbide. The obtained high temperature resistance cemented carbide has a durable temperature resistance of 1000° C., a hardness of HRC55. In other words, the hardness at 1000° C. is HRC55. The pressure resistance at room temperature is 4.0 GPa. And the high temperature resistance cemented carbide has good corrosion resistance and oxidation resistance.

It is worth mentioning that, according to this first example, the molding agent, such as sodium butadiene rubber is mixed to the first mixed powder after the tungsten carbide powder and the binder phase powder are mixed together. One skilled in the art can understand that the molding agent can also be directly mixed with the tungsten carbide powder and the binder phase powder while the tungsten carbide powder and the binder phase powder are mixed. According to other embodiments, the molding agent can also be mixed to the tungsten carbide powder or the binder phase powder first and then the binder phase powder or tungsten carbide powder is mixed.

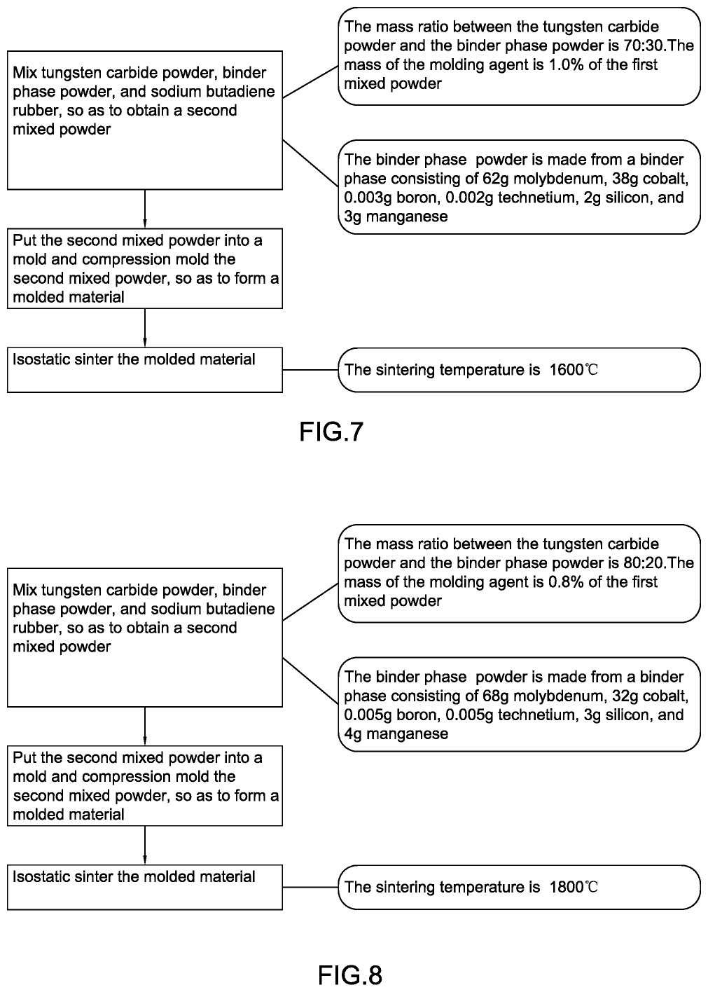

FIG. 7 illustrates a second example of the manufacturing method of the high temperature resistant cemented carbide according to the preferred embodiment of the present invention. The method comprises the following steps.

Mix 70 g tungsten carbide powder, 30 g binder phase powder, and 1.0 g sodium butadiene rubber, so as to obtain a second mixed powder.

Put the second mixed powder into a mold and compression mold the second mixed powder.

Isostatic sinter the molded material, wherein after the temperature rises to 1600° C., the temperature is maintained for 2 hours. Then release the vacuum pressure and fill argon into the furnace for 3 hours. After the pressure in the furnace reaches to 11 MPa, the temperature is maintained for 6 h.

What is different from the first example of the present invention, the binder phase material comprises 62 g molybdenum, 38 g cobalt, 0.003 g boron, 0.002 g technetium, 2 g silicon, and 3 g manganese. The binder phase material is melted and alloyed at 1600° C. .

According to this second example, the obtained high temperature resistance cemented carbide has a durable temperature resistance of 1200° C., a hardness of HRC56.

In other words, the hardness at 1200° C. is HRC56. The pressure resistance at room temperature is 4.5 GPa. And the high temperature resistance cemented carbide has good corrosion resistance and oxidation resistance.

FIG. 8 illustrates a third example of the manufacturing method of the high temperature resistant cemented carbide according to the preferred embodiment of the present invention. The method comprises the following steps.

Mix 80 g tungsten carbide powder, 20 g binder phase powder, and 0.8 g sodium butadiene rubber, so as to obtain a second mixed powder.

Put the second mixed powder into a mold and compression mold the second mixed powder.

Isostatic sinter the molded material, wherein after the temperature rises to 1800° C., the temperature is maintained for 2 hours. Then release the vacuum pressure and fill argon into the furnace for 3 hours. After the pressure in the furnace reaches to 11 MPa, the temperature is maintained for 6 h.

What is different from the preferred embodiment of the present invention, the binder phase material comprises 68 g molybdenum, 32 g cobalt, 0.005 g boron, 0.005 g technetium, 3 g silicon, and 4 g manganese. The binder phase material is melted and alloyed at 1800° C.

According to this third example, the obtained high temperature resistance cemented carbide has a durable temperature resistance of 1400° C., a hardness of HRC58. In other words, the hardness at 1400° C. is HRC58. The pressure resistance at room temperature is 5.0 GPa. And the high temperature resistance cemented carbide has good corrosion resistance and oxidation resistance.

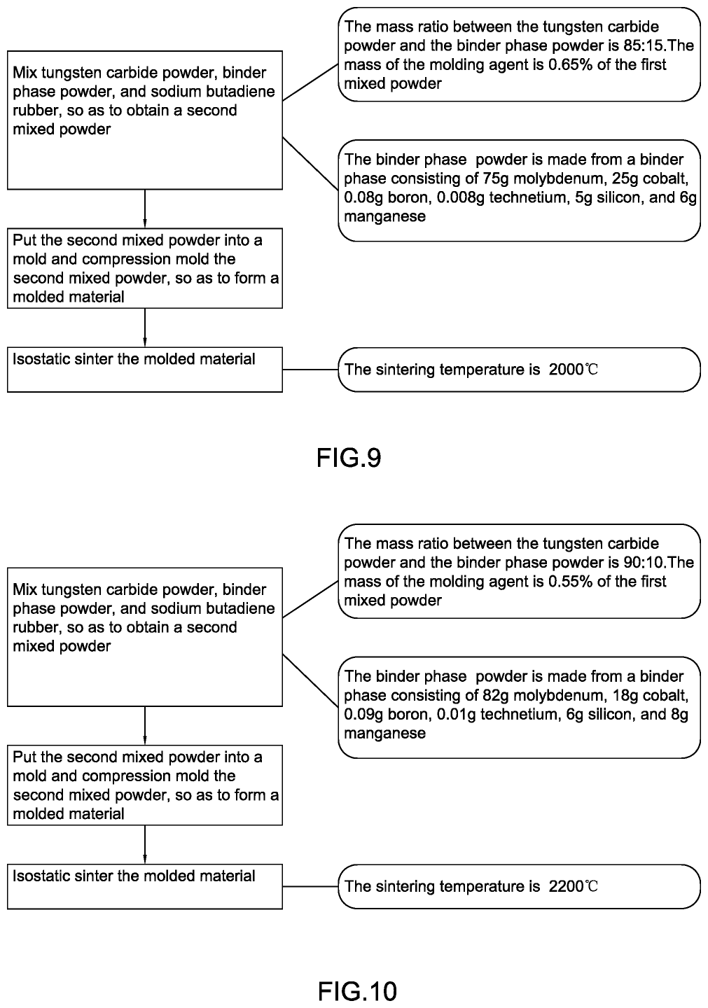

FIG. 9 illustrates a fourth example of the manufacturing method of the high temperature resistant cemented carbide according to the preferred embodiment of the present invention. The method comprises the following steps.

Mix 85 g tungsten carbide powder, 15 g binder phase powder, and 0.65 g sodium butadiene rubber, so as to obtain a second mixed powder.

Put the second mixed powder into a mold and compression mold the second mixed powder.

Isostatic sinter the molded material, wherein after the temperature rises to 2000° C., the temperature is maintained for 2 hours. Then release the vacuum pressure and fill argon into the furnace for 3 hours. After the pressure in the furnace reaches to 12 MPa, the temperature is maintained for 6 hours.

What is different from the preferred embodiment of the present invention, the binder phase material comprises 75 g molybdenum, 25 g cobalt, 0.08 g boron, 0.008 g technetium, 5 g silicon, and 6 g manganese. The binder phase material is melted and alloyed at 2100° C.

According to this fourth example, the obtained high temperature resistance cemented carbide has a durable temperature resistance of 1600° C., a hardness of HRC60. In other words, the hardness at 1600° C. is HRC60. The pressure resistance at room temperature is 5.8 GPa. And the high temperature resistance cemented carbide has good corrosion resistance and oxidation resistance.

FIG. 10 illustrates a fifth example of the manufacturing method of the high temperature resistant cemented carbide according to the preferred embodiment of the present invention. The method comprises the following steps.

Mix 90 g tungsten carbide powder, 10 g binder phase powder, and 0.55 g sodium butadiene rubber, so as to obtain a second mixed powder.

Put the second mixed powder into a mold and compression mold the second mixed powder.

Isostatic sinter the molded material, wherein after the temperature rises to 2200° C., the temperature is maintained for 2 hours. Then release the vacuum pressure and fill argon into the furnace for 3 hours. After the pressure in the furnace reaches to 11 MPa, the temperature is maintained for 6 hours.

What is different from the preferred embodiment of the present invention, the binder phase material comprises 82 g molybdenum, 18 g cobalt, 0.09 g boron, 0.01 g technetium, 6 g silicon, and 8 g manganese. The binder phase material is melted and alloyed at 2200° C.

According to this fifth example, the obtained high temperature resistance cemented carbide has a durable temperature resistance of 1800° C., a hardness of HRC62. In other words, the hardness at 1800° C. is HRC62. The pressure resistance at room temperature is 6.5 GPa. And the high temperature resistance cemented carbide has good corrosion resistance and oxidation resistance.

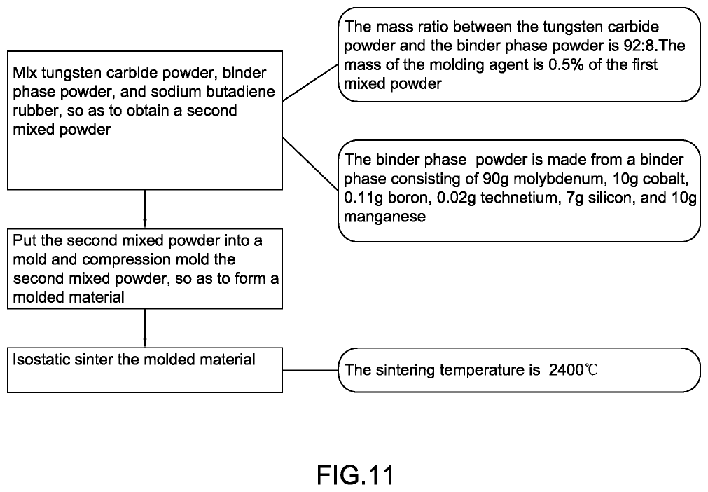

FIG. 11 illustrates a sixth example of the manufacturing method of the high temperature resistant cemented carbide according to the preferred embodiment of the present invention. The method comprises the following steps.

Mix 92 g tungsten carbide powder, 8 g binder phase powder, and 0.5 g sodium butadiene rubber, so as to obtain a second mixed powder.

Put the second mixed powder into a mold and compression mold the second mixed powder.

Isostatic sinter the molded material, wherein after the temperature rises to 2400° C., the temperature is maintained for 2 hours. Then release the vacuum pressure and the argon is filled for 3 hours. After the pressure in the furnace reaches to 12 MPa, the temperature is maintained for 6 hours.

What is different from the fifth example of the present invention is that, the binder phase comprises 90 g molybdenum, 10 g cobalt, 0.11 g boron, 0.02 g technetium, 7 g silicon, and 10 g manganese. The binder phase material is melted and alloyed at 2400° C.

According to this sixth example, the obtained high temperature resistance cemented carbide has a durable temperature resistance of 2000° C., a hardness of HRC64. In other words, the hardness at 2000° C. is HRC64. The pressure resistance at room temperature is 6.8 GPa. And the high temperature resistance cemented carbide has good corrosion resistance and oxidation resistance.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A cemented carbide having a high temperature resistance, wherein the cemented carbide is manufactured and sintered from a tungsten carbide powder having a mass percentage of 60% to 92% and a binder phase powder having a mass percentage of 8% to 40%, wherein the binder phase powder comprises 40 to 90 parts of molybdenum, 10 to 60 parts of cobalt, 0.001 to 0.11 part of boron, 0.001 to 0.02 part of technetium, 1 to 7 parts of silicon, and 2 to 10 parts of manganese.

2. The cemented carbide, as recited in claim 1, wherein a particle size of the binder phase powder is 1 to 100 nm.

3. The cemented carbide, as recited in claim 1, wherein a particle size of the tungsten carbide powder is 1 to 100 nm.

4. The cemented carbide, as recited in claim 2, wherein a particle size of the tungsten carbide powder is 1 to 100 nm.

5. A method of manufacturing a high temperature resistance cemented carbide, comprising the steps of:
(A) mixing tungsten carbide powder and binder phase powder, so as to form a first mixed powder comprising the tungsten carbide powder and the binder phase powder, wherein a mass percentage of the tungsten carbide powder is 60% to 92%, a mass percentage of the binder phase powder is 8% to 40%;
(B) adding molding agent into the first mixed powder, so as to form a second mixed powder;
(C) compression molding the second mixed powder to obtain a molded material; and
(D) isostatic sintering the molded material.

6. The method, as recited in claim 5, wherein in the step (B), a mass of the molding agent is 0.5% to 1.2% of the first mixed powder.

7. The method, as recited in claim 6, wherein a particle size of the tungsten carbide powder is 1 to 100 nm.

8. The method, as recited in claim 7, wherein a particle size of the binder phase powder is 1 to 100 nm, wherein the binder phase powder comprises 40 to 90 parts of molybdenum, 10 to 60 parts of cobalt, 0.001 to 0.11 part of boron, 0.001 to 0.02 part of technetium, 1 to 7 parts of silicon, and 2 to 10 parts of manganese.

9. The method, as recited in claim 7, before the step (A), further comprising the steps of:
(a) bombarding a tungsten carbide target with argon ions in an argon vacuum sputtering machine, so as to form the tungsten carbide powder; and
(b) keeping the argon vacuum sputtering machine being standing still for 10 to 25 days to obtain the tungsten carbide powder which is dropped into a powder collection device through a hopper device provided in the vacuum chamber of the argon vacuum sputtering machine for collecting the tungsten carbide powder.

10. The method, as recited in claim 8, before the step (A), further comprising the steps of:
(α) bombarding a binder phase target with argon ions in an argon vacuum sputtering machine, so as to form the binder powder; and
(β) keeping the argon vacuum sputtering machine being standing still for 10 to 25 days to obtained the binder phase powder which is dropped into a powder collection device through a hopper device provided in the vacuum chamber of the argon vacuum sputtering machine for collecting the binder phase powder.

11. The method, as recited in claim 9, before the step (A), further comprising the steps of:
(α) bombarding a binder phase target with argon ions in an argon vacuum sputtering machine, so as to form the binder powder; and
(β) keeping the argon vacuum sputtering machine being standing still for 10 to 25 days to obtain the binder phase powder which is dropped into a powder collection device through a hopper device provided in the vacuum chamber of the argon vacuum sputtering machine for collecting the binder phase powder.

12. The method, as recited in claim 5, wherein the step (D) comprises the steps of:
(D1) putting the molded material into a sintering furnace;
(D2) evacuating the sintering furnace and heat the sintering furnace to a second predetermined temperature and keeping the second predetermined temperature in the sintering furnace for 0.5 to 2.0 h;
(D3) feeding argon into the sintering furnace till a pressure in the sintering furnace reaches to 8 to 15 MPa;
(D4) maintaining the temperature in the sintering furnace for 3 to 6 h; and
(D5) cooling the sintering furnace to room temperature.

13. The method, as recited in claim 12, wherein the second predetermined temperature is 1600° C. to 2400° C.

14. The method, as recited in claim 8, wherein a sintering temperature in the step (D) is 1600° C. to 2400° C.

15. A cemented carbide having a high temperature resistance, wherein the cemented carbide is manufactured by a method comprising the steps of:
(A) mixing tungsten carbide powder and binder phase powder, so as to form a first mixed powder comprising the tungsten carbide powder and the binder phase powder, wherein a mass percentage of the tungsten carbide powder is 60% to 92%, a mass percentage of the binder phase powder is 8% to 40%;
(B) adding molding agent into the first mixed powder, so as to form a second mixed powder;
(C) compression molding the second mixed powder to obtain a molded material; and
(D) isostatic sintering the molded material.

16. The cemented carbide, as recited in claim 15, wherein in the step (B), a mass of the molding agent is 0.5% to 1.2% of the first mixed powder.

17. The cemented carbide, as recited in claim 16, wherein the binder phase powder comprises 40 to 90 parts of molybdenum, 10 to 60 parts of cobalt, 0.001 to 0.11 part of boron, 0.001 to 0.02 part of technetium, 1 to 7 parts of silicon, and 2 to 10 parts of manganese.

18. The cemented carbide, as recited in claim 17, wherein a particle size of the tungsten carbide powder is 1 to 100 nm, wherein a particle size of the binder phase powder is 1 to 100 nm.

19. The cemented carbide, as recited in claim 17, wherein before the step (A), the method further comprises the steps of:
(a) bombarding a tungsten carbide target with argon ions in an argon vacuum sputtering machine, so as to form the tungsten carbide powder; and
(b) keeping the argon vacuum sputtering machine being standing still for 10 to 25 days to obtain the tungsten carbide powder which is dropped into a powder collection device through a hopper device provided in the vacuum chamber of the argon vacuum sputtering machine for collecting the tungsten carbide powder.

20. The cemented carbide, as recited in claim 18, wherein before the step (A), the method further comprises the steps of:
(α) bombarding a binder phase target with argon ions in an argon vacuum sputtering machine, so as to form the binder powder; and
(β) keeping the argon vacuum sputtering machine being standing still for 10 to 25 days to obtain the binder phase powder which is dropped into a powder collection device through a hopper device provided in the vacuum chamber of the argon vacuum sputtering machine for collecting the binder phase powder.

21. The cemented carbide, as recited in claim 19, wherein before the step (A), the method further comprises the steps of:
(α) bombarding a binder phase target with argon ions in an argon vacuum sputtering machine, so as to form the binder powder; and
(β) keeping the argon vacuum sputtering machine being standing still for 10 to 25 days to obtain the binder phase powder which is dropped into a powder collection device through a hopper device provided in the vacuum chamber of the argon vacuum sputtering machine for collecting the binder phase powder

22. The cemented carbide, as recited in claim 15, wherein step (D) comprising the steps of:
(D1) putting the molded material into a sintering furnace;
(D2) evacuating the sintering furnace and heat the sintering furnace to a second predetermined temperature and keeping the second predetermined temperature in the sintering furnace for 0.5 to 2.0 h;
(D3) feeding argon into the sintering furnace till a pressure in the sintering furnace reach to 8 to 15 MPa;
(D4) maintaining the temperature in the sintering furnace for 3 to 6 h; and
(D5) cooling the sintering furnace to room temperature.

23. The cemented carbide, as recited in claim 22, wherein the second predetermined temperature is 1600° C. to 2400° C.

24. The cemented carbide, as recited in claim 15, wherein a sintering temperature in the step (D) is 1600° C. to 2400° C.
